(19) United States
(12) Patent Application Publication
(10) Pub. No.: US 2011/0255947 A1
(43) Pub. Date: Oct. 20, 2011

(54) Vehicle Winch Side-Mount System

(75) Inventors: David Scuito, Molalla, OR (US); Mitchell R. Lawson, Vancouver, WA (US); Randy C. Karambelas, Milwaukie, OR (US)

(73) Assignee: WARN INDUSTRIES, INC., Milwaukie, OR (US)

(21) Appl. No.: 12/762,713

(22) Filed: Apr. 19, 2010

(51) Int. Cl. F16M 13/02

(52) U.S. Cl. 414/800; 248/224.8; 296/1.07

(57) ABSTRACT

A vehicle winch side-mount system including a platform and a winch mounting structure configured to engage a mount of a winching device. The vehicle winch side-mount system is configured to be retained by the weight a vehicle tire.

### FIELD

The present disclosure relates to a mount for a vehicle winch, and more particularly, a vehicle winch side-mount system that is designed for a vehicle tire to be driven onto a platform of the side-mount system.

### BACKGROUND

This section provides background information related to the present disclosure which is not necessarily prior art.

Vehicles, such as a pickup truck, a sport utility vehicle (SUVs), or a large utility truck such as a fire truck, are often equipped with a receiver hitch mounted on a support bracket located on the front or rear bumper of the vehicle. Winches mounted to the receiver hitch can be used to perform a variety of tasks, such as pulling a large object using the mass of the vehicle to anchor the winch and a winch cable.

However, it should be appreciated that in some situations operation of the winch mounted to the front or rear of the vehicle limits the position of the vehicle. As the large object is being pulled back toward the vehicle a tremendous amount of force is being exerted on the winch. If the object being pulled is located in a position other than the front or rear of the vehicle, the angle on the winch affects the working load limit. This in turn can render the winch useless.

In some vehicular applications it is desirable to pull a large object from the side of the vehicle. This would require a winch to be mounted to the side of the vehicle similar to a winch mounted to the front or rear of the vehicle. A receiver hitch mounted on a support bracket is not aesthetically pleasing on the side of a vehicle nor functionally in operating the vehicle. Additionally the side of the vehicle is not constructed to have a bumper like the front or rear of the vehicle.

### SUMMARY

This section provides a general summary of the disclosure, and is not a comprehensive disclosure of its full scope or all of its features.

In some embodiments, a vehicle winch side-mount system includes a platform having a top surface, the top surface being sized to receive a vehicle tire thereon. The vehicle side-mount system also includes a mounting structure coupled to the platform, and a receiver mounted to the mounting structure. The receiver is operable to receive a device.

In some embodiments, a vehicle winch side-mount system includes a platform having a top surface, the top surface being sized to receive a vehicle tire thereon. The platform is moveable between folded and unfolded positions for easier storage. The vehicle side-mount system also includes a mounting structure coupled to the platform and a receiver mounted to the mounting structure.

In some embodiments, a vehicle is driven onto the platform of the vehicle winch side-mount system. The tire of the vehicle is positioned on the top surface of the platform, the top surface being sized to receive the vehicle tire thereon. The mount of winching device is engaged to the receiver that is mounted to the mounting structure. The mounting structure is coupled to the platform.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view of a vehicle winch side-mount system having a platform, a mounting structure, and a receiver according to the principles of the present disclosure shown in an extended position.

FIG. 2 is a perspective view a vehicle winch side-mount system having a platform, a mounting structure and a receiver according to the principles of the present disclosure shown in a folded position.

FIG. 3 is a perspective view of a vehicle winch side-mount system having a platform, a mounting structure and a receiver according to some embodiments of the present disclosure shown in an extended position.

FIG. 4 is a perspective view of the vehicle winch side-mount system of FIG. 3 having a platform, a mounting structure and a receiver according to the principles of the present disclosure with the platform shown in an folded position.

FIG. 5 is a front view of the vehicle winch side-mount system of FIG. 1 with a vehicle tire positioned on top of the platform according to the principles of the present disclosure.

FIG. 6 is a perspective view of the vehicle winch side-mount system of FIG. 1 with a mount of a winching device engaged with a receiver according to the principles of the present disclosure.

Corresponding reference numerals indicate corresponding parts throughout the several views of the drawings.

### DETAILED DESCRIPTION

Example embodiments will now be described more fully with reference to the accompanying drawings.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

According to an embodiment of the present disclosure, an apparatus and method is provided for using a vehicle winch side-mount system. The vehicle winch side-mount system is designed to be portable and mounted underneath a tire of a vehicle. Once the vehicle tire is positioned on the vehicle winch side-mount system platform, the weight of the vehicle prevents the vehicle side-mount system from generally moving during a winching operation. In effect, the weight of the vehicle and the associated frictional factors anchor the vehicle winch side-mount system to the ground. The vehicle winch side-mount system allows for more versatility than a traditional front or rear mounted winch, improved portability, and use with several vehicles irrespective as to whether such vehicles are equipped with traditional towing hardware.

It is understood from the present disclosure, the device to be mounted to the mounting structure is not limited to just a winch. Other devices may be mounted to this vehicle side-mount system of the present disclosure such as a crane, a pulling and/or lifting device, a platform, or other types of devices that can be mounted into a receiver. Moreover, it should be appreciated that any desired device or mounting hardware can be used in place of the illustrated and described receiver.

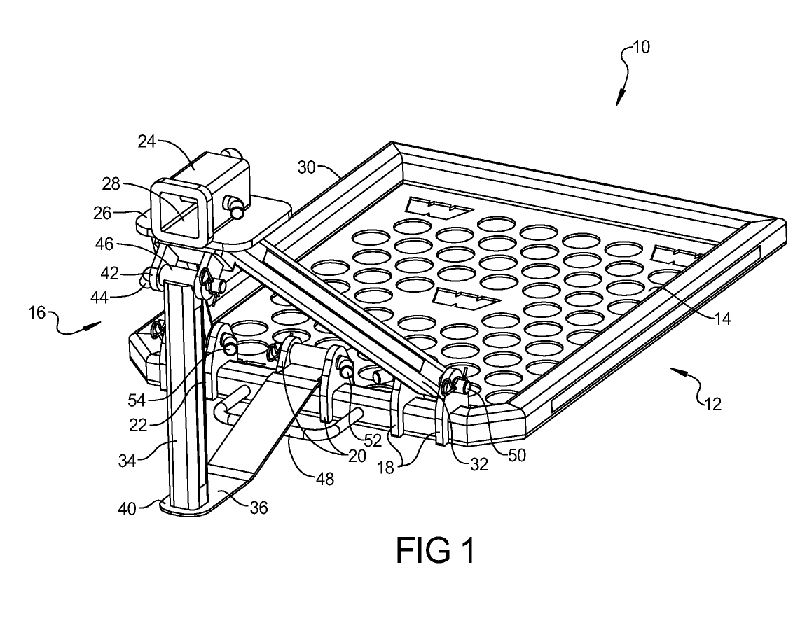

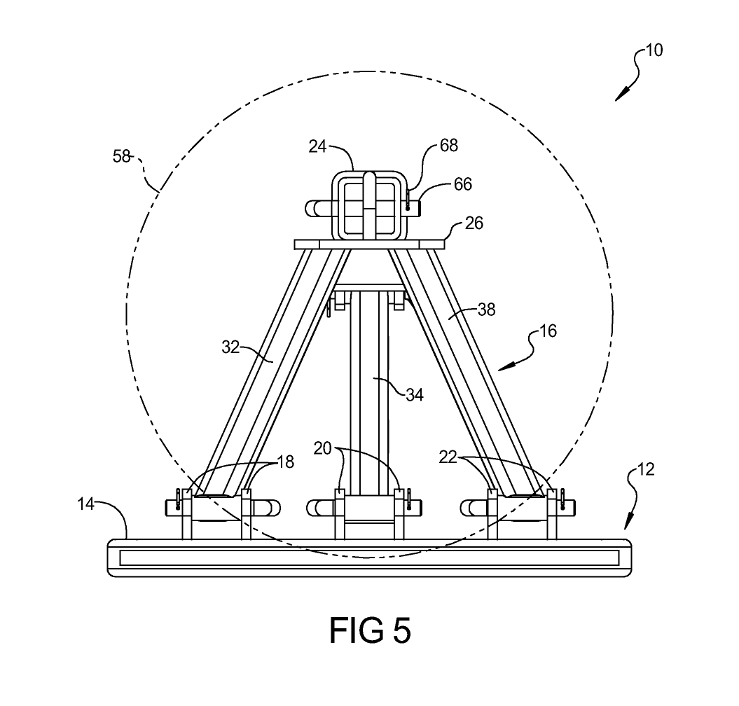

With reference to FIG. 1, a vehicle winch side-mount system 10 suited for vehicular applications (FIG. 5) is illustrated according to the principles of the present teachings. The vehicle winch side-mount system 10 includes a platform 12. The platform 12 has a top surface 14. The top surface 14 is sized to receive a vehicle tire thereon. The top surface 14 may be perforated. The perforations on the top surface 14 may ease the strain on the platform between the weight of the vehicle and the ground once the vehicle tire is in position and/or reduce the outset weight of the vehicle winch side-mount system 10.

The vehicle winch side-mount system 10 also includes a mounting structure 16. In some embodiments, the mounting structure 16 is coupled to the platform 12. By way of non-limiting example, the mounting structure 16 may be coupled to the platform 12 by brackets, fasteners, clips or the like. In some embodiments, the mounting structure 16 is coupled to the platform 12 by at least one set of brackets 18 or by a plurality of brackets 20, 22. The brackets 18, 20, 22 can be located on front of the top surface 14 of the platform 12.

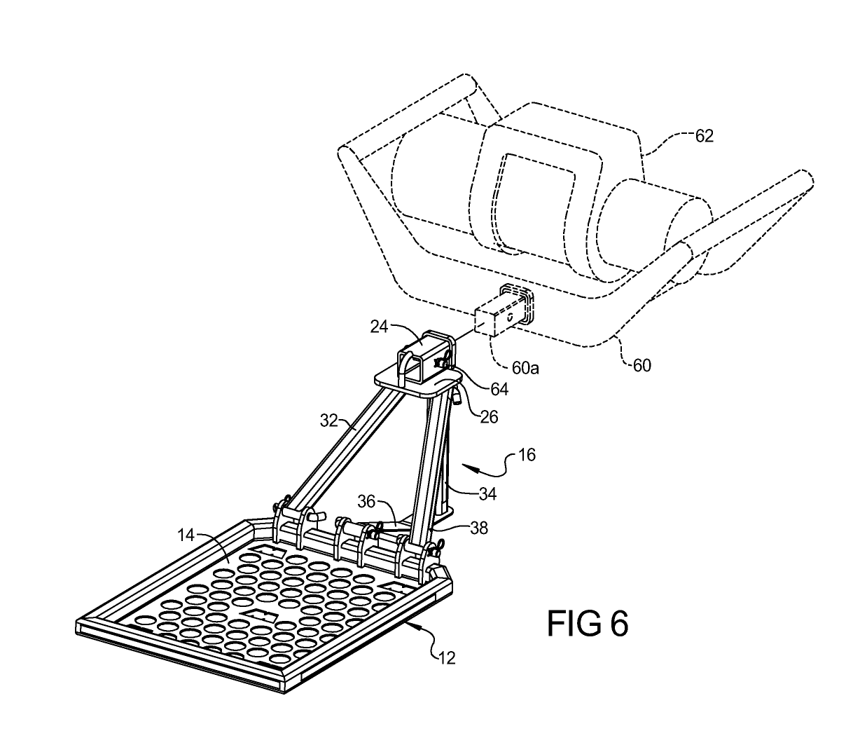

In some embodiments, the vehicle winch side-mount system 10 includes a receiver 24. The receiver 24 is mounted to the mounting structure 16 by a central receiver platform 26. The receiver 24 may have an opening 28 to receive a mount of a winching device (both shown in FIG. 6), thereby securing the mount to the mounting structure 16 and the platform 12. The opening size 28 may be 1.25 inches to 2.5 inches depending on the type of mount being secured. As used herein the term “receiver” should be understood to be any receiver such as a class 1 through 4 receiver, gooseneck receiver, or any other type of receiver. The receiver 24 may also secure a hook rather than a mount of a device. It should be understood the configuration of the receiver is not limited to just a traditional trailer hitch receiver.

In some embodiments, for additional strength, the platform 12 may include a reinforcement structure 30. The reinforcement structure 30 can be fixedly coupled to the platform 12 and the mounting structure 16. The reinforcement structure 30 being designed to reinforce the platform 12 strength between the weight of the vehicle and the ground once the vehicle tire is in position and during the winching operation. In other words, the reinforcement structure 30 may be provided to more adequately manage loading forces during placement of the vehicle winch side-mount system 10 and any operation thereof. The reinforcement structure 30 may be designed to be a tubular U-shaped, have ribs along the top surface 14 of the platform 12, or individual tubular sections along the outer edge of the top surface 14 of the platform 12.

The mounting structure 16 counteracts the lateral forces while the winch is in operation. The mounting structure 16 transfers the lateral forward forces of the winch backwards to the platform 12. The mounting structure 16 can counteract these forces by having at least one support column 32, a support tube 34 and a support plate 36. These components 32, 34, 36 work together to stabilize the receiver 24 by lessening the tensional forces on the receiver and transferring the work load to the platform 12 and the vehicle.

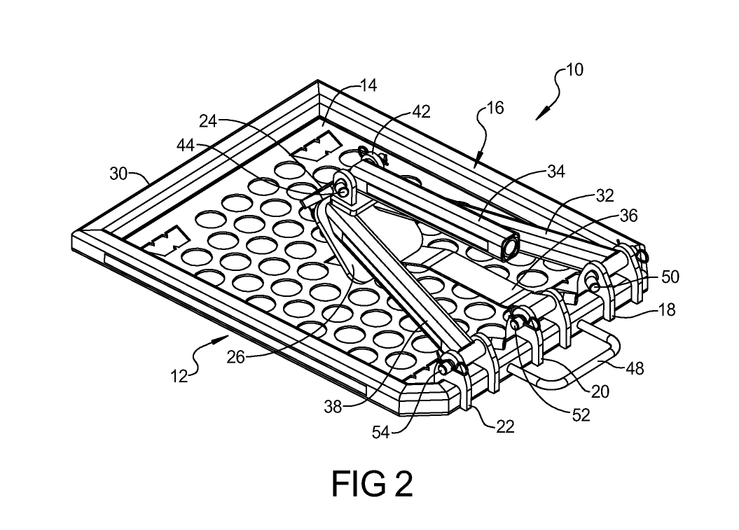

The mounting structure 16 includes at least one support column 32 that fixedly connects to the receiver 24 by the central platform 26. In some embodiments, the mounting structure 16 includes two support columns 32, 38, as illustrated in FIG. 2. When the winch is in operation each support column 32, 38 helps to maintain the structural integrity of the vehicle side-mount system 10 by preventing the receiver 24 from rotating or being pulled forward.

In some embodiments, for added strength, the mounting structure 16 may include the support plate 36. The support plate 36 helps to maintain the structural integrity of the vehicle side-mount system 10 by preventing the support tube 34 from rotating or being pulled forward. The support tube 34 is secured to the support plate 36 by a central foot 40. The central foot 40 connects to the support tube 34, preventing lateral movement of the support tube 34 during the winching operation. The connection between the support tube 34 and the central foot 40 are created by the torsional forces of the winching operation. This forces the support tube 34 down onto the central foot 40.

Additionally, the support tube 34 can pivotally connect to the receiver 24 by a bracket 42. The bracket 42 can include a hitch pin 44. The hitch pin 44 is inserted through an aperture in the bracket 42 and then through a sleeve 46 and out the other side of another aperture in the bracket 42. The hitch pin 44 allows the support tube 34 to be pivotally or releasably connected to the receiver 24.

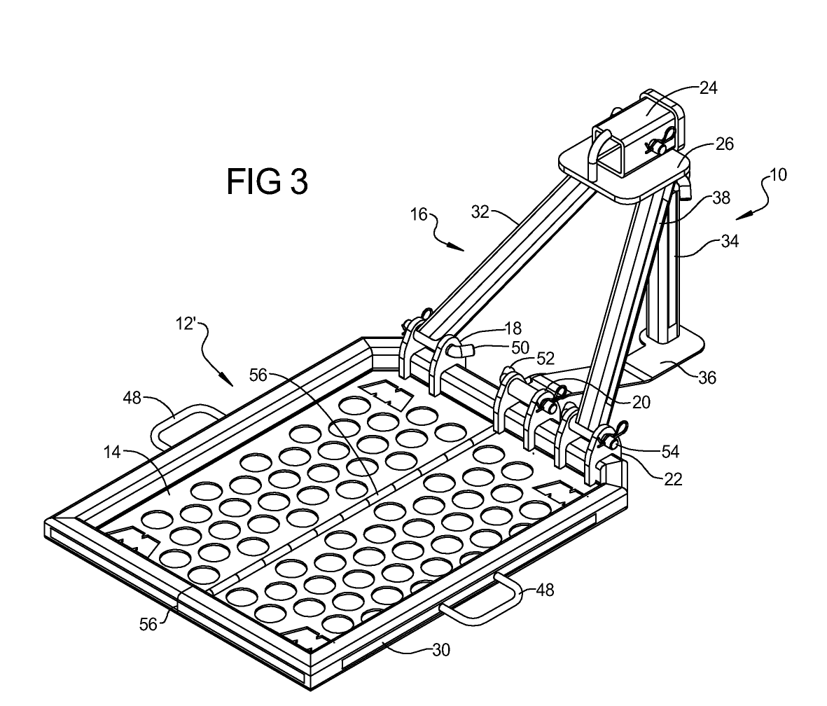

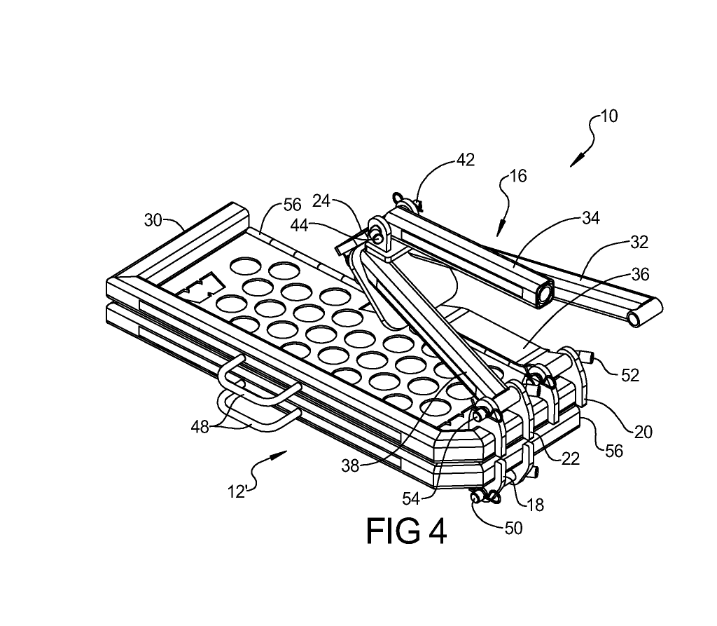

Referencing now FIGS. 1-4, in some embodiments, the vehicle side-mount system 10 includes a handle 48 fixedly coupled to the platform 12. As illustrated in FIGS. 1-2, the handle 48 may be fixedly coupled to the front of the platform 12. In some embodiments, as illustrated in FIGS. 3-4 the handle 48 may be fixedly coupled to the opposing sides of the platform 12 (FIG. 3). With the vehicle side-mount system 10 being portable, the handle 48 makes it easier to manipulate the vehicle side-mount system 10 on the ground, to carry the vehicle side-mount system 10, and to store the vehicle side-mount system 10.

Additionally for ease in storing the vehicle side-mount system 10 the mounting structure 16 may be pivotally mounted to the platform 12 by brackets 18, 20, 22. Each bracket 18, 20, 22 can include a hitch pin 50, 52, 54 that is inserted into the brackets 18, 20, 22. The hitch pins 50, 52, 54 allow the mounting structure 16 to be moveable between extended (FIGS. 1 and 3) and folded (FIGS. 2 and 4) positions. The receiver 24 being connected to the support columns 32, 38 is moveable with the mounting structure 16. The support tube 34 can be released from the receiver 24 for more compact storage.

The mounting structure 16 of the vehicle side-mount system 10 may also be releasably mounted to the platform 12. The mounting structure 16 can be released from the brackets 18, 20, 22 by removing the hitch pins 50, 52, 54. The vehicle side-mount system 10 may then be stored in two different pieces, the platform 12 and the mounting structure 16. Additionally, the support tube 34 can be released from the receiver 24 for more compact storage.

Referring now to FIGS. 3 and 4, in some embodiments, the vehicle winch side-mount system 10 includes a platform 12′ having a top surface 14. The top surface 14 is sized to receiver a vehicle tire thereon. The platform 12′ is moveable between an extended and folded position. The vehicle side-mount system 10 includes the mounting structure 16 that is coupled to the platform 12′ and the receiver 24 that is mounted to the mounting structure 16.

The platform 12′ can be folded along a hinge 56. In some embodiments, the hinge 56 is fixedly coupled to the top surface 14 of the platform 12′. Folding the platform 12′ allows for even more compact storage. The mounting structure 16 may be pivotally connected to the platform 12. Upon folding the platform 12′, the mounting structure 16 and receiver 24 can be moved into a folded position. In some embodiments, the mounting structure 16 is releasably connected to the platform 12′ such that upon folding the platform 12′, the mounting structure 16 and receiver 24 can be detached from the platform 12′ and stored in two pieces. In either configuration, the support tube 34 can be released from the receiver 24 for more compact storage.

With reference to the operation for using the vehicle winch side-mount system 10 will be described. Referring to FIG. 5, a vehicle operator can drive a vehicle onto the platform 12. The operator will position the tire 58 of the vehicle on the top surface 14 of the platform 12. The weight of the vehicle anchors the platform 12 to ground, preventing the platform from being pulled during the winching operation.

In some embodiments, the mounting structure 16, coupled to the platform 12, can be secured to the vehicle tire 58, if additional reinforcement is necessary. This can be done using a safety strap, harness, a belt, or any other means of securing the mounting structure 16 to the vehicle tire 58. In some embodiments, the safety strap is tightened around the mounting structure 16 and the tire 58. This adds another counteraction in addition to the mounting structure 16 that keeps the vehicle side-mount system 10 in place during operation and transfers the pulling forces back to the platform 12 and the vehicle.

Referring now to FIG. 6, a mount 60 supports a winching device 62 and includes a mount post 60a which can be engaged with the receiver 24 that mounts to the mounting structure 16. In some embodiments, the mount post 60 slidably engages the receiver, although other conventional mounting connections can be used. Once the mount post 60a slides into the receiver 24, a locking mechanism 64 secures the mount post 60a to the receiver 24. The locking mechanism 64 can include a hinge pin 66 and a locking pin 68 (FIG. 5). The hinge pin 66 is inserted through the receiver 24 and the mount post 60a. The locking pin 68 is inserted laterally through the hinge pin 66. The locking mechanism 64 prevents further lateral movement of the mount post 60a once it is engaged.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

What is claimed is:

1. A vehicle side-mount system comprising:
a platform having a top surface, the top surface being sized to receive a vehicle tire;
a mounting structure coupled to the platform; and
a receiver mounted to the mounting structure, the receiver operable to receive a device.

2. The vehicle side-mount system of claim 1, further comprising a reinforcement structure fixedly coupled between of the platform and the mounting structure.

3. The vehicle side-mount system of claim 1, further comprising a handle fixedly coupled to the platform.

4. The vehicle side-mount system of claim 1 wherein the mounting structure and the receiver are moveable between an extended and folded positions.

5. The vehicle side-mount system of claim 1 wherein the mounting structure is pivotally connected to the platform.

6. The vehicle side-mount system of claim 1 wherein the mounting structure is releasably coupled to the platform.

7. The vehicle side mount system of claim 1 wherein the mounting structure comprises at least one support column, a support tube, and a support plate stabilizing the receiver.

8. The vehicle side-mount system of claim 7 wherein the at least one support column is fixedly connected to the receiver.

9. The vehicle side-mount system of claim 7 wherein the support tube is pivotally connected to the receiver.

10. The vehicle side-mount system of claim 7 wherein the support plate comprising a central foot connected to the support tube that minimizes relative movement of the support tube and the receiver.

11. A vehicle winch side-mount system comprising:
a platform having a top surface, the top surface being sized to receive a vehicle tire thereon, the platform is moveable between an unfolded and folded position;
a mounting structure coupled to the platform; and
a receiver mounted to the mounting structure, the receiver operable to receive a device.

12. The vehicle side-mount system of claim 11 including a hinge fixedly coupled to the top surface of the platform.

13. The vehicle side mount system of claim 11 wherein the mounting structure includes a mounting structure having at least one support column, a support tube, and a support plate stabilizes the receiver.

14. The vehicle side-mount system of claim 11 wherein the mounting structure and the receiver are moveable between an extended and folded positions.

15. A method for using a vehicle winch side-mount system, the method comprising:
driving a vehicle onto a platform;
positioning a tire of the vehicle on a top surface of the platform, the top surface being sized to receive a vehicle tire thereon; and
engaging a mount of a winching device with a receiver mounted to a mounting structure, the mounting structure coupled to the platform.

16. The method of claim 15 further comprising connecting a locking mechanism to the mount of the winch device and to the receiver.

17. The method of claim 15 wherein further comprising securing the mounting structure to the vehicle tire.

18. The method of claim 15 wherein the mounting structure comprising least one support column, a support tube, and a support plate stabilizing the receiver when the winch device is operated.
